(19) United States
(12) Patent Application Publication
(10) Pub. No.: US 2003/0168557 A1
(43) Pub. Date: Sep. 11, 2003

(54) Pedestal seat support with shock-absoring apparatus

(76) Inventor: George P. Semienko, Franklin, MA (US)

Correspondence Address: Damon J. Borrelli, Esq, 100 Border Road, Needham, MA, 02492, US

(21) Appl. No.: 10/093,720

(22) Filed: Mar. 11, 2002

(51) Int. Cl. F16M 11/00; F16M 13/00

(52) U.S. Cl. 248/157; 248/624

(57) ABSTRACT

Disclosed is a pedestal support apparatus. The disclosed apparatus includes an inner tubular element that is telescopically received into an outer tubular element. A shock-absorber element is positioned within the chambers created by the inner tubular element and outer tubular element. A bearing element is positioned between the inner tubular element and outer tubular element. The bearing element serves to facilitate relative movement between the inner and outer tubular elements. The bearing element also acts to fix the inner tubular element and outer tubular element in rotational position relative to each other.

### BACKGROUND OF THE INVENTION

1. Field of the Invention

The present invention relates to shock-absorbing apparatuses. More particularly, the invention relates to a shock-absorbing apparatus for use in connection with pedestal seats.

2. Description of the Prior Art

Pedestal seats are utilized in a wide variety of applications. These seats typically include a vertical support element upon which a support for a seat cushion is positioned. The support element typically includes elements permitting, for example, height adjustment or rotation about an axis. As necessary for a given application, the support element can be configured for either static or dynamic height, and directional, adjustment. The seat cushion support may include elements for positioning and supporting a seat cushion, back cushion, and arm rests. Additional elements, such as footrests may also be connected to the seat cushion support.

Pedestal seats configured for static applications, such as in a barbershop, generally include elements positioned in the support element of the pedestal seat that can be used to fixably set the height, and rotational direction, of the seat cushion support. In this type of pedestal seat, the height of the seat cushion support is adjusted and then fixed, i.e., locked, in position. Likewise, the rotational position of the seat cushion support, although adaptable, is typically locked in position so as to prevent substantially any rotational movement.

Pedestal seats employed in connection with marine applications must be configured in order to meet a myriad of unique operational requirements. First, like pedestal seats used for static applications, a marine pedestal seat must be capable of supporting a selected weight. Further, pedestal seats utilized in marine applications must be able to be set to a fixed height and rotational orientation. Unlike other pedestal seats, however, a seat utilized in a marine application must also be configured so that it can quickly, and repeatedly, adapt to changing forces. These forces may be axial, lateral, rotational, or combinations of all of these types of forces depending upon, for example, the forces generated by the impact of waves upon the vessel. Further, as the seat adapts to these forces, it must be able to repeatedly return to the height and orientation selected by a user. Finally, the pedestal seat must be able to perform all of these functions in a hostile environment typified by the corrosive effects of salt water.

Currently available pedestal seat apparatuses for use in marine applications do not satisfy the range of operational requirements noted above. This failure is a result of both the complexity and mechanical deficiencies of currently available marine pedestal seats.

In general, those apparatuses that are currently available for marine applications are typically a complex combination of bearings and springs. This design complexity frequently results in significant, and catastrophic, structural failures that cannot be remedied without replacement of substantially all of the pedestal seat apparatus. These design complexities can also result in the seats failing to conform to industry standards. This later limitation is a direct result of the inability of manufactures to produce effective pedestal seats incorporating support elements with external configurations substantially identical to those utilized in most marine applications. As a result of this later limitation, consumers are often forced to replace virtually unused components, e.g., bracket assemblies, at a significant cost, in order to install currently available pedestal seats. Further, the unique size and configuration of those pedestal seats that are currently available limits the interchanging of parts. As a result, failure of one part of an apparatus forces a consumer to use only a replacement part designed specifically for the given seat that is damaged. This last limitation is especially problematic when it is considered that in marine applications repair parts may not be readily available if a ship is, for example, at sea.

A need has arisen for a pedestal seat conforming to industry standards that does not suffer from the foregoing limitations and that can be easily, and economically, manufactured.

### SUMMARY OF THE INVENTION

It is an object of the present invention to provide a pedestal seat support that does not suffer from the foregoing disadvantages and limitations.

It is another object of the present invention to provide a pedestal seat support that is simple in construction and compact in design.

It is yet another object of the present invention to provide a pedestal seat support that is easy to install and maintain.

It is yet another object of the present invention to provide a pedestal seat support that can be used in a marine application.

It is yet another object of the present invention to provide a pedestal seat support that is easily and economically produced, and readily assembled.

Other general and specific objects of the invention will in part be obvious and will in part appear hereinafter.

The pedestal seat support of the invention is characterized by an inner tubular element, a bearing element, an outer tubular element, and an extension element. The inner tubular element is telescopically, and removalbly and replaceably, received by the outer tubular element. The bearing element is positioned between the inner tubular element and outer tubular element. The extension element is affixed to the outer tubular element.

The inner tubular element extends longitudinally along an axis and has a substantially circular cross-sectional configuration. The inner tubular element has an inner surface and an outer surface. The inner surface defines a chamber into which a shock-absorbing element is positioned. The outer surface of the inner tubular element is configured to facilitate interconnection of the inner tubular element with the bearing element. To achieve this goal, at least a portion of the outer surface includes a series of lans and grooves. Typically, the lans and grooves are substantially equally spaced and oriented so as to extend within the body of the inner tubular element in a radial pattern relative to the axis. The lans and grooves extend longitudinally along the outer surface. The outer surface also includes a recessed portion defining a retaining ring element configured to interferingly engage a portion of the bearing element. A series of three apertures are typically positioned in the inner tubular element and configured to receive bolts or screws that, in turn secure a restraining element, and thus shock-absorbing element, in position.

The outer tubular element also extends longitudinally along an axis. The outer tubular element has a substantially circular cross-sectional configuration. The outer tubular element is configured to telescopically receive the inner tubular element. Like the inner tubular element, the outer tubular element has an inner surface and an outer surface. The inner surface assists to define the chamber into which the shock-absorbing element is positioned when the pedestal seat support of the invention is fully assembled. The inner surface is also configured to facilitate interconnection of the outer tubular element with the bearing element. In particular, the inner surface includes a series of lans and grooves that engage the bearing element. A series of three apertures are typically positioned in the outer tubular element and configured to receive bolts or screws that, in turn secure a restraining element, and, thus, shock-absorbing element, in position.

Extending from the outer tubular element is an extension element. The extension element includes a flange that assists to position the extension element vis-à-vis the outer tubular member. The extension element is configured to removeably and replaceably receive a support for a seat cushion.

Positioned between the outer tubular element and inner tubular element is the bearing element. The bearing element has a substantially cylindrical body extending longitudinally along an axis. The bearing element includes a series inwardly and outwardly radially, extending projections. These projections have a size, shape, and spacing that is complementary to the size, shape, and spacing of the lans and grooves of the inner tubular element and the outer tubular element.

Positioned in the chamber cooperatively created by the inner surfaces of the inner tubular element and outer tubular element is the shock-absorbing element. The shock-absorbing element includes a cylinder and a piston. A rod is connected to the piston and extends longitudinally along the axis from one end of the shock-absorbing element. A spring element can surround the combination of the cylinder and rod. The spring element, if utilized, is selected so that that it has a resiliency that will permit adaptation by the shock-absorbing element to a variety of axial forces.

Two retaining elements support the shock-absorbing element in the chamber. The restraining elements have a substantially rectangular aperture located in their central region. The aperture is configured to receive a portion of the shock-absorbing element. The retraining elements have a substantially circular outer configuration. More particularly, their outer configuration is selected so that the restraining elements will interferringly engage, as appropriate, the inner surface of the inner tubular element and the inner surface of the extension element.

It will thus be seen that the invention efficiently attains the objects set forth above, among those made apparent from the preceding description.

It will be understood that changes may be made in the above construction and in the foregoing sequences of operation without departing from the scope of the invention. It is accordingly intended that all matter contained in the above description or shown in the accompanying drawings be interpreted as illustrative rather than in a limiting sense.

It is also to be understood that the following claims are intended to cover all of the generic and specific features of the invention as described herein, and all statements of the scope

The invention accordingly comprises the apparatus embodying features of construction, combinations of elements, and arrangements of parts, as exemplified in the following detailed disclosure, the scope of the invention is indicated in the claims.

### BRIEF DESCRIPTION OF THE DRAWINGS

For a fuller understanding of the nature and objects of the invention, reference should be made to the following detailed description and the accompanying drawings, in which:

FIG. 1 is a cut-away side view of a pedestal seat support embodying the invention;

FIG. 2 is a cross-sectional view, through line A-A of FIG. 1, of a pedestal seat support embodying the invention;

FIG. 3 is a top perspective view of the first upper portion of the inner tubular element;

FIG. 4 is a top perspective view of a bearing element useful in connection with the embodiment of the invention as shown in FIG. 1;

FIG. 5 is an exploded view of the pedestal seat support embodying the invention as shown in FIG. 1 depicting the inner tubular element, outer tubular element, extension element, and bearing element;

FIG. 6A is a top plan view of the restraining element used in connection with the pedestal seat support embodying the invention as shown in FIG. 1;

FIG. 6B is a side view of the restraining element used in connection with the pedestal seat support embodying the invention as shown in FIG. 1.

### DESCRIPTION OF PREFERRED EMBODIMENTS

The invention features a pedestal seat support having a simple, efficient configuration. The pedestal seat support of the invention includes an inner tubular element, an outer tubular element, an extension element, and a bearing element. The invention provides a pedestal seat support that can be utilized in connection with a wide variety of marine seats. In operation, the pedestal seat support of the invention is capable of reacting efficiently to a myriad of dynamic forces. The pedestal seat support of the invention can be fixed at a variety of heights and rotational orientations.

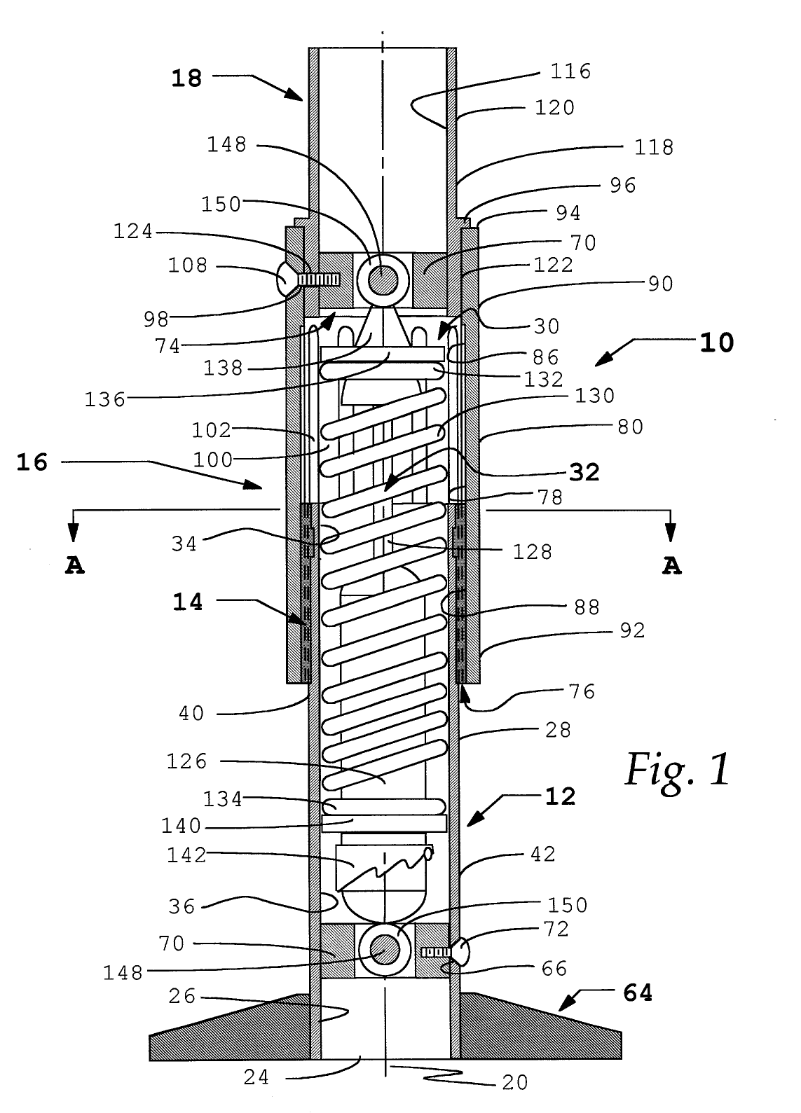

Referring to FIGS. 1 through 6B wherein like reference numerals refer to like parts, there is illustrated the pedestal seat support of the invention 10. The pedestal seat support of the invention 10 is characterized by an inner tubular element 12, a bearing element 14, an outer tubular element 16, and an extension element 18. The inner tubular element 12 is telescopically, and removalbly and replaceably, received by the outer tubular element 16. The bearing element 14 is positioned between the inner tubular element 12 and outer tubular element 16. The extension element 18 is affixed to the outer tubular element 16.

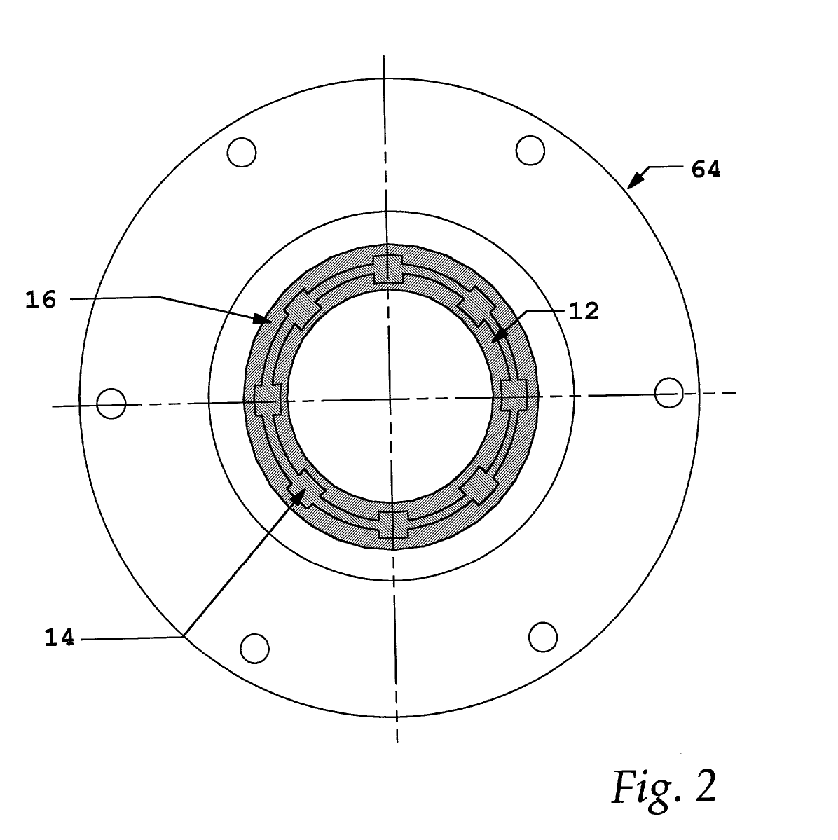

The inner tubular element 12 extends longitudinally along an axis 20 and has, as shown in FIG. 2 and discussed in greater detail below, a substantially circular cross-sectional configuration. The inner tubular element 12 has a first open end 22 and a second open end 24. The inner tubular element 12 has an inner surface 26 and an outer surface 28. The inner surface 26 defines a chamber 30 into which a shock-absorbing element 32 is positioned when the pedestal seat support of the invention 10 is fully assembled as shown in FIG. 1. As discussed in detail below, the outer surface 28 is configured to facilitate interconnection of the inner tubular element 12 with the bearing element 14 and base 64. As individuals skilled-in-the-art will appreciate, the inner tubular element 12 can be manufactured from virtually any dynamically stable material having the requisite mechanical strength. Typical materials utilized in connection with the construction of the inner tubular element 12 include aluminum and stainless steel. Aluminum is the preferred material for the inner tubular element 12 when the pedestal seat apparatus of the invention 10 is to be utilized in marine applications.

The inner surface 26 includes a first upper portion 34 that serves to define the first open end 22. The inner surface 26 also includes a second lower portion 36 that serves to define the second open end 24. The first portion 34 and second portion 36 are continuous, and axially aligned along the axis 20, with each other.

The first portion 34 of the inner surface 26 is continuous with the first open end 22 and defines, as shown in FIG. 1, at least a portion of the chamber 30. The first portion 34 of inner surface 26 has a substantially circular cross-sectional configuration. Finally, the first portion 34 of the inner surface 26 has an inner diameter 13 dimensioned to removably and replaceably receive a shock-absorbing element 32 described in detail below. In the preferred embodiment of the pedestal seat apparatus of the invention 10, the diameter 13 is substantially constant along the length of the inner surface 26 of the inner tubular element 12. That is, the diameter of the second portion 36 is substantially identical to diameter 38.

The second portion 36 of the inner surface 26 of the pedestal seat support of the invention 10 is continuous with the second open end 24 of the inner tubular element 12. Like the first portion 34 the second portion 36 serves to define at least a portion of the chamber 30. The inner surface 26 of the second portion 36 also typically has a substantially circular cross-sectional configuration. As noted above, the diameter of the second portion 36 is, preferably, substantially identical to diameter 13. In the preferred embodiment of the pedestal seat apparatus of the invention 10, the diameter of the second portion 36 is substantially constant along the length of this portion of the inner surface 26 of the inner tubular element 12.

As noted above, the outer surface 28 is configured to facilitate interconnection of the inner tubular element 12 with the bearing element 14. The outer surface 28 includes a first upper portion 40 and a second lower portion 42. The first portion 40 and second portion 42 are continuous, and axially aligned along the axis 20, with each other. The outer surface 28 has an outer diameter 50 dimensioned to interferingly receive the bearing element 14 described in detail below. In the preferred embodiment of the pedestal seat apparatus of the invention 10, the diameter 50 is substantially constant along the length of the outer surface 28 of the inner tubular element 12. That is, the diameter of the second portion 42 is also substantially identical to diameter 50.

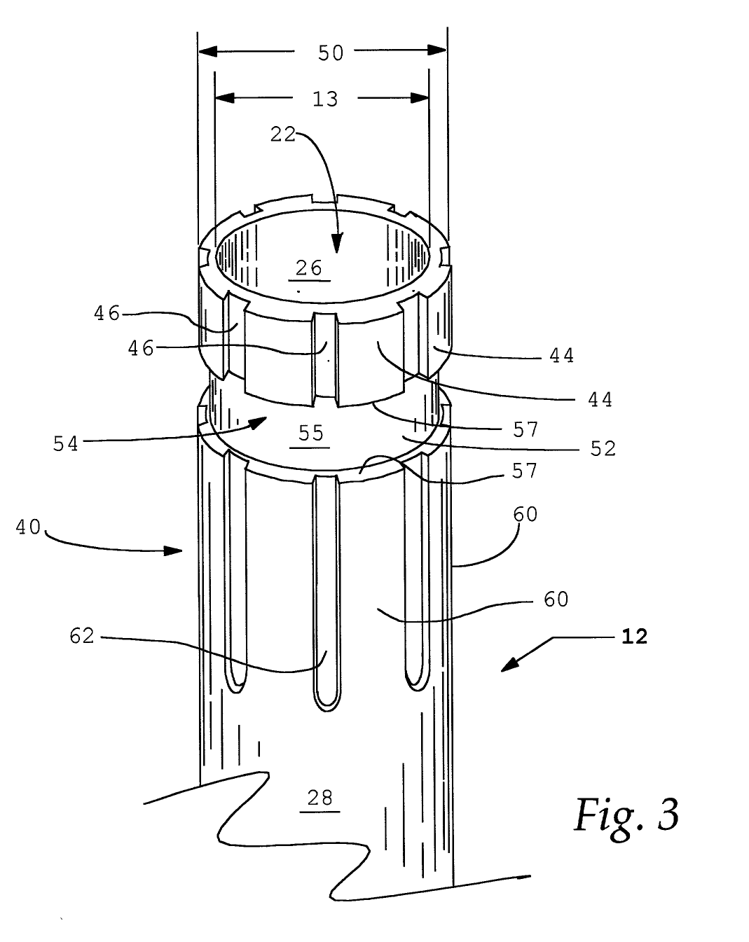

The first portion 40 of the outer surface 28 defines the upper portion of the outer wall 28 of the inner tubular element 12. As shown best in FIG. 3, that section of the first portion 40 that is most proximal to the open end 22 includes a series of lans 44 and grooves 46. The grooves 46 are lanced into the first portion 40 of the outer surface 28.

Typically, the lans 44 and grooves 46 are substantially equally spaced and oriented so as to extend within the body of the inner tubular element 12 in a radial pattern relative to the axis. The lans 44 and grooves 46 extend longitudinally along the outer surface 28. The grooves 46 are of substantially equal depth. For the reasons stated below, the grooves 46 are configured to be complementary with the inner projections 48 of the bearing element 14. Although eight sets of lans 44 and grooves 46 are depicted in FIG. 3, those individuals skilled-in-the-art will appreciate that virtually any number of lans 44 and grooves 46 can be utilized depending upon the application and providing that the number selected does not adversely effect the overall structural integrity of the inner tubular element 12.

Proximal to the lans 44 and grooves 46 is a recessed portion 52. The recessed portion 52 defines a retaining ring element 54. The retaining ring element 54 is configured such that its outer surface 55 will interferingly engage a shoulder element 58 of the bearing element 14. Opposing shoulder elements 57 of the lans 44 and 60 further assist to secure the bearing element 14 in the retaining ring element 54. In order to achieve the desired configuration for the retaining ring element 54, in the preferred embodiment of the invention as shown in the several FIGURES, the outer diameter of the retaining ring element 54 is less than that diameter as defined by the deepest portion of the grooves 46.

That section of the outer surface 28 that is most distal to the open end 22 also includes a series of lans 60 and grooves 62. One end of the grooves 62 are open, and continuous, into the retaining ring element 54. The opposing end of the grooves 62 are configured so as to end in a substantially semicircular configuration. Alternatively, if desired, the depth of the grooves 62 can be configured to decrease over their longitudinal run such that the bottom surface of the groove 62 is eventually flush, i.e., continuous, with the outer surface 28 at that point most distal from the open end 22.

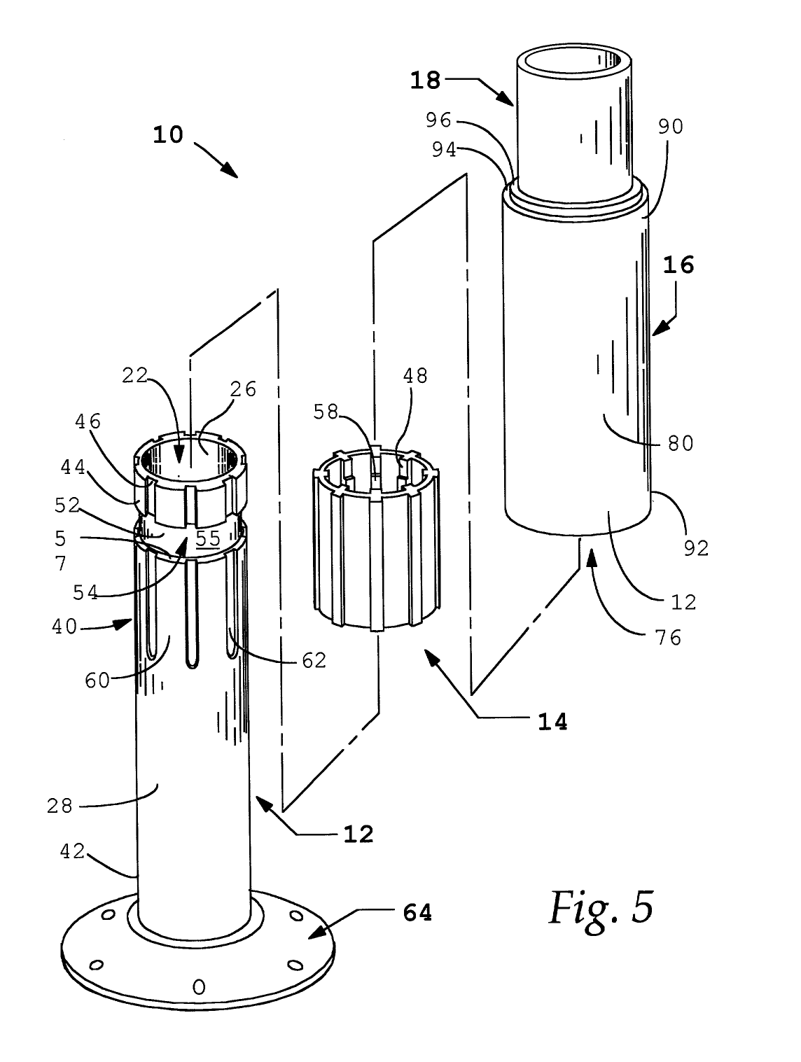

The second portion 42 of the inner tubular element 12 defines the lower portion of the outer wall 28 of the inner tubular element 12. The outer wall 28 of the second portion 42 can have virtually any configuration. Typically, the outer wall 28 of the second portion 42 has a configuration that will permit positioning of the inner tubular element 12 in the base 64 or other attachment assembly as shown in FIGS. 1 and 5.

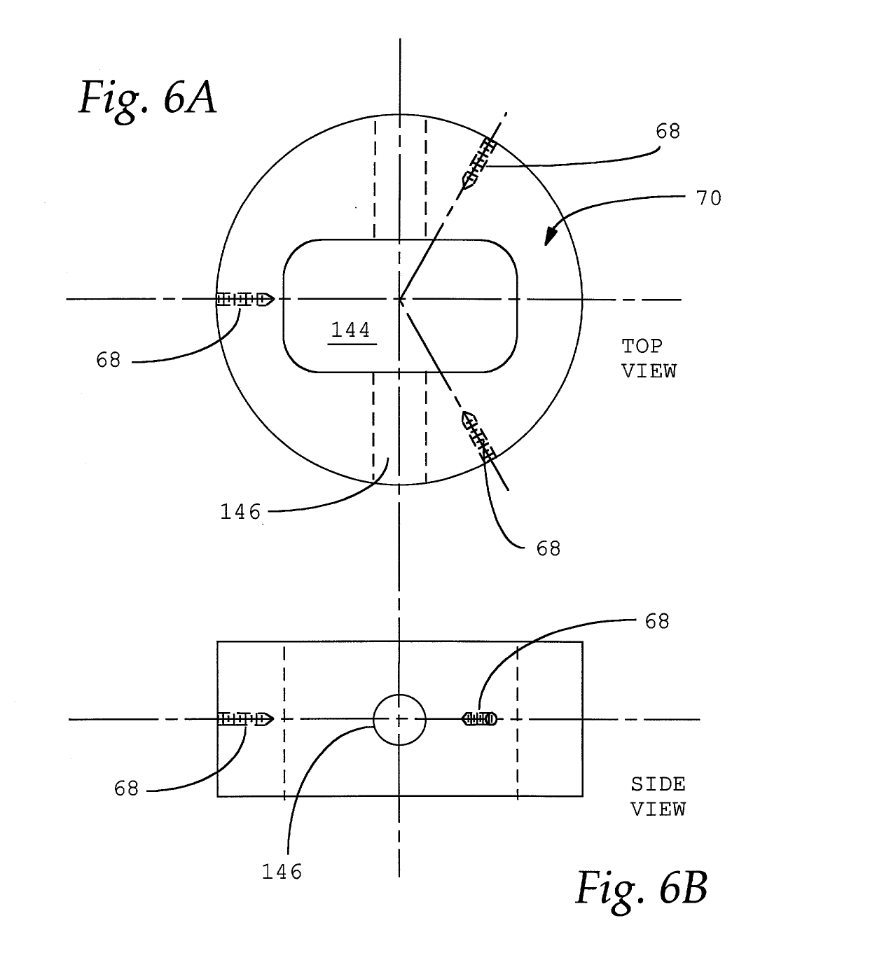

A series of three apertures 66 are positioned in the second portions 36 and 42 of the inner tubular element 12. More particularly, the apertures 66 extend from the outer surface 28 of the second portion 42 to the inner surface 26 of the second portion 36. The apertures 66 are radially aligned about the axis 20. In the preferred embodiment of the invention as shown in the several FIGURES, the apertures 66 are oriented at an angle of about one hundred twenty degrees relative to each other. This orientation is preferred since is permits alignment of the apertures 66 with apertures 68 in a restraining element 70, described in detail below and shown in FIGS. 6A and 6B, when the pedestal seat support of the invention 10 is fully assembled as shown in FIG. 1. The apertures 66 are sized to receive a screw, bolt, or other attachment mechanism 72 appropriate for this application and familiar to those skilled-in-the-art.

The outer tubular element 16 also extends longitudinally along the axis 20. The outer tubular element 16 has, as shown in FIG. 2 and discussed in greater detail below, a substantially circular cross-sectional configuration. The outer tubular element 16 is configured to telescopically receive the inner tubular element 12. The outer tubular element 16 has a first open end 74 and a second open end 76. The outer tubular element 16 has an inner surface 78 and an outer surface 80. The inner surface 78, in cooperation with the inner surface 26, defines the chamber 30 into which the shock-absorbing element 32 is positioned when the pedestal seat support of the invention 10 is fully assembled as shown in FIG. 1. As discussed in detail below, the inner surface 78 is configured to facilitate interconnection of the outer tubular element 16 with the bearing element 14. The inner surface 78 is also configured to receive at least a portion of an extension element 18 upon which a seat cushion support can be positioned. As individuals skilled-in-the-art will appreciate, the outer tubular element 16 can be manufactured from virtually any dynamically stable material having the requisite mechanical strength. Typical materials utilized in connection with the construction of the outer tubular element 16 include aluminum and stainless steel. Aluminum is the preferred material for the outer tubular element 16 when the pedestal seat apparatus of the invention 10 is to be utilized in marine applications.

The inner surface 78 includes a first upper portion 86 that serves to define the first open end 74. The inner surface 78 also includes a second lower portion 88 that serves to define the second open end 76. The first portion 86 and second portion 88 are continuous, and axially aligned along the axis 20, with each other.

The first portion 86 of the inner surface 78 is continuous with the first open end 74 and defines at least a portion of the chamber 30. The first portion 86 of inner surface 78 has a substantially circular cross-sectional configuration. Finally, the first portion 86 of the inner surface 78 has an inner diameter dimensioned to removably and replaceably receive the shock-absorbing element 32 described in detail below. In the preferred embodiment of the pedestal seat apparatus of the invention 10, the diameter of the inner surface 78 is substantially constant along substantially the entire the length of the inner surface 78 of the outer tubular element 16. That is, the inner diameter of the second portion 88 is substantially identical to diameter of the first portion 86.

The first portion 86 of the inner surface 78 of the outer tubular element 16 defines a portion of the inner wall of the outer tubular element 16. The inner surface 78 of the first portion 86 is configured to receive at least a portion of the extension element 18 in interfering engagement. The first portion 86 includes a supporting face 94 configured to receive a flange 96 integral with the extension element 18.

The second portion 88 of the inner surface 78 is continuous with the second open end 76 of the outer tubular element 16. Like the first portion 86, the second portion 88 serves to define at least a portion of the chamber 30. The inner surface 78 of the second portion 88 also typically has a substantially circular cross-sectional configuration. As noted above, the diameter of the second portion 88 is, preferably, substantially identical to the diameter of the first portion 86. In the preferred embodiment of the pedestal seat apparatus of the invention 10, the diameter of the second portion 88 is substantially constant along the length of this portion of the inner surface 78 of the outer tubular element 16. The second portion 88 of the inner surface 78 is configured to facilitate interconnection of the outer tubular element 16 with the bearing element 14.

The second portion 88 of the inner surface 78 includes a series of lans 100 and grooves 102. The grooves 102 are lanced into the first portion 88 of the inner surface 78.

Typically, the lans 100 and grooves 102 are substantially equally spaced and positioned radially relative to the axis 20. The lans 100 and grooves 102 extend longitudinally along the inner surface 78. The grooves 102 are of substantially equal depth. For the reasons stated below, the grooves 102 are configured to be complementary with the outer projections 104 of the bearing element 14. Although eight sets of lans 100 and grooves 102 are depicted in the several FIGURES, those individuals skilled-in-the-art will appreciate that virtually any number of lans 100 and grooves 102 can be utilized depending upon the application and providing that the number selected does not adversely effect the structural integrity of the outer tubular element 16 as a whole.

The outer surface 80 includes a first upper portion 90 and a second lower portion 92. The first portion 90 and second portion 92 are continuous, and axially aligned along the axis 20, with each other. The outer surface 80 has an outer diameter dimensioned to be compatible with the overall configuration of the pedestal seat support of the invention 10. In the preferred embodiment of the pedestal seat apparatus of the invention 10, the diameter of the outer surface 80 is substantially constant along the length of the outer surface 80 of the outer tubular element 16.

A series of three apertures 98 are positioned in the outer tubular element 16. More particularly, the apertures 98 extend from the outer surface 80 to the inner surface 78 of the first portion 86. The apertures 98 extend through the body of the outer tubular element 16 in radial directions vis-à-vis the axis 20. In the preferred embodiment of the invention as shown in the several FIGURES, the apertures 98 are oriented at an angle of about one hundred twenty degrees relative to each other. This orientation is preferred since is permits alignment of the apertures 98 with apertures 68 in a restraining element 70, described in detail below and shown in FIGS. 6A and 6B, and apertures 124 in the extension element 18 when the pedestal seat support of the invention 10 is fully assembled as shown in FIG. 1. The apertures 98 are sized to receive a screw, bolt, or other attachment mechanism 108 appropriate for this application and familiar to those skilled-in-the-art.

Extending from the outer tubular element 16 is an extension element 18. The extension element 18 has an inner surface 116 and an outer surface 118. The inner surface is sized and shaped to receive the restraining element 70 described in detail below. The outer surface 118 of the extension element 18 has a first upper portion 120 and a second lower portion 122. Defining the separation between the first upper portion 120 and second lower portion 122 is a flange 96. The flange 96 is sized and shaped to engage the supporting face 94 of the outer tubular element 16.

The first upper portion 120 is configured to removeably and replaceably receive a support for seat cushion (not shown). Accordingly, the outer wall surface 118 of the upper portion 120 is configured such that it complements the seat supports of majority of the available seat cushions currently on the market.

The second lower portion 122 is configured to interferingly engage the inner surface 78 of the outer tubular element 16. Accordingly, the outer wall surface 118 of the second lower portion 122 is configured such that it is complementary to the configuration of the inner surface 78 of the outer tubular element 16. The second lower portion 122 also includes a series of apertures 124 configured to be co-axially alignable with the apertures 98 in the outer tubular element 16. Like the apertures 98, the apertures 124 are also sized and shaped to receive the bolt, screw or other connection element 108.

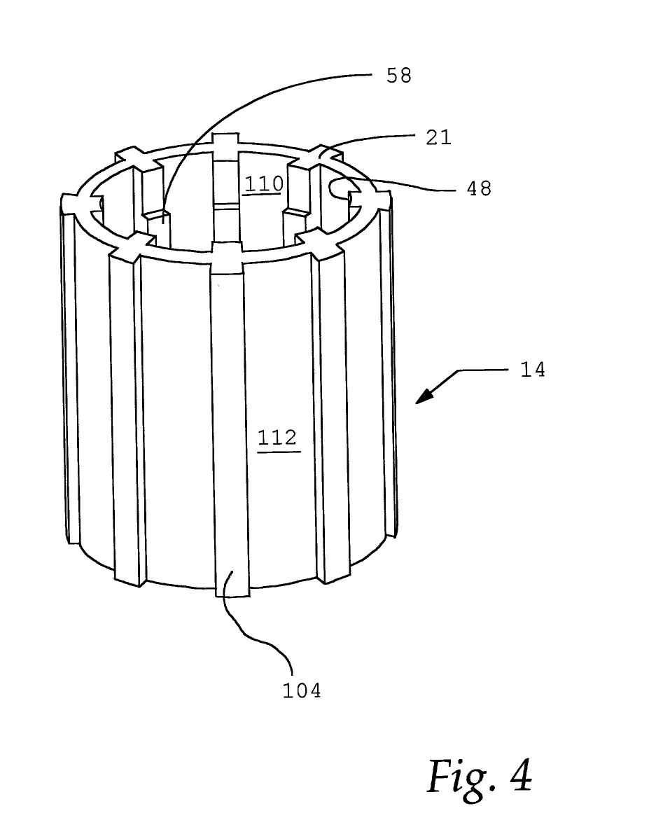

Positioned between the outer tubular element 16 and inner tubular element 12 is the bearing element 14. As best shown in FIGS. 4 and 5, the bearing element 14 has a substantially cylindrical body 21. That is, the bearing element extends longitudinally along an.

FIG. 1, the bearing element 14 extends longitudinally along the axis 20. More particularly, the bearing element 14 is positioned so that is its axis 20 is co-axial with axis 20 that defines the inner tubular element 12 and outer tubular element 16. The bearing element 14 has an inner wall surface 110 and an outer wall surface 112. The bearing element 14 can be manufactured from deformable materials familiar to those skilled-in-the-art such as UHMW Polyethylene.

The inner wall surface 110 of the bearing element 14 has an inner diameter that is selected to interferingly engage the outer surface 28 of the inner tubular element 12. The inner wall surface 110 of the bearing element 14 includes a series inwardly, and radially, extending projections 48. The projections 48 have a size, shape, and spacing that is complementary to the size, shape, and spacing of the lans 44 and 60 and grooves 46 and 62 of the outer surface 28 of the inner tubular element 12. As noted previously, the projections 48 also include a shoulder 58. The shoulder 58 is configured to be complementary in size and shape to the recessed portion 52 of the restraining ring element 54 in the outer surface 28 of the inner tubular element 12. In operation, the shoulder 58 is positioned within the recessed portion 52 of the restraining ring element 54 in order to prevent axial, i.e., upward and downward, movement of the bearing element 14.

The outer wall surface 112 of the bearing element 14 has an outer diameter that is selected to slidably engage the inner surface 78 of the outer tubular element 16. The outer wall surface 112 of the bearing element 14 also includes a series outwardly, and radially, extending projections 104. The projections 104 have a size and shape that is complementary to the size and shape of the lans 100 and grooves 102 of the inner surface 78 of the outer tubular element 16.

Positioned in the chamber 30 cooperatively created by the inner surface 26 of the inner tubular element 12 and the inner surface 78 of the outer tubular element 16 is the shock-absorbing element 32. The shock-absorbing element 32 includes a cylinder portion 126 with a piston (not shown) positioned therein. A rod 128 is connected to the piston and extends longitudinally along the axis 20 from one end of the shock-absorbing element 32. A spring element 130 can surround the combination of the cylinder 126 and rod 128. When employed, the spring element 130 has a first upper end 132 and a second lower end 134. The first upper end 132 of the spring element 130 is positioned on a seating flange 136 that is integral with an end cap 138 positioned on the end of the rod 128. The second lower end 134 of the spring element 130 is positioned on a second seating flange 140. This second seating flange 140 is integral with the end piece 142 positioned on the end of the cylinder 126. An individual eyelet 150 is connected to each of the end cap 138 and end piece 142. The spring element 130, if utilized, is selected so that it has a resiliency that will permit adaptation by the shock-absorbing element 32 to a variety of axial forces.

Two retaining elements 70 support the shock-absorbing element 32 in the chamber 30. As shown in FIGS. 6A and 6B, the restraining elements 70 have a substantially rectangular aperture 144 located in their central region. The aperture 144 is configured, as appropriate, to receive the eyelets 150 that are connected to the end caps 138 and 142 of the shock-absorbing element 32. The restraining elements 70 also include an aperture 146. When the pedestal seat support of the invention 10 is fully assembled as shown in FIG. 1, the aperture 146 receives a pin 148 that passes through the eyelets 150 in the end caps 138 and 142. The pin 148, in cooperation with the apertures 146 and eyelets 150 serves to secure the shock-absorbing element 32 in position within the chamber 30. As shown in FIG. 6A, the retraining elements 70 have a substantially circular outer configuration. More particularly, their outer configuration is selected so that the restraining elements 70 will interferringly engage, as appropriate, the inner surface 26 of the inner tubular element 12 and inner surface 116 of the extension element 18. The restraining elements 70 are held in position by, typically, the attachment elements 72 and 108 discussed herein above.

FIG. 5 depicts the generalized sequence required to assemble the pedestal seat support of the invention 10. To commence assembly, the bearing element 14 is press fitted on the inner tubular element 12. In particular, the bearing element 14 is pressed onto the inner tubular element 12 until the shoulder element 58 of the bearing element 14 is positioned in the restraining ring element 54 of the inner tubular element 12. The projections 48 of the bearing element 14 are positioned in the lans 44 and 60 and grooves 46 and 62 of the inner tubular element 12 in order to correctly align the bearing element 14 vis-à-vis the inner tubular element 12.

In the next phase of the assembly process, the restraining element 70, with shock-absorbing element 32 attached thereto, is positioned within the chamber 30 of the inner tubular element 12 and then secured in position using the screws 72.

The outer tubular member 16 is then telescopically positioned over the inner tubular element 12. More particularly, the lans 100 and grooves 102 in the inner surface 78 of the outer tubular element 16 are aligned with the projections 104 extending from the outer wall surface 112 of the bearing element 14. The projections 104 are then permitted to slide along the lans 100 and grooves 102 until the projections 104 are fully seated in their appropriate lans 100 and grooves 102. As this action occurs, the restraining element 70, and related shock-absorbing element 32, move into the chamber 30.

To complete the assembly process, the restraining element 70 is secured in position using the screws 108. The pedestal seat support of the invention 10 can then be secured to a deck via base 64 or other mounting device.

It will thus be seen that the invention efficiently attains the objects set forth above, among those made apparent from the preceding description.

It will be understood that changes may be made in the above construction and in the foregoing sequences of operation without departing from the scope of the invention. It is accordingly intended that all matter contained in the above description or shown in the accompanying drawings be interpreted as illustrative rather than in a limiting sense.

It is also to be understood that the following claims are intended to cover all of the generic and specific features of the invention as described herein, and all statements of the scope of the invention which, as a matter of language, might be said to fall therebetween.

Having described the invention, what is claimed as new and secured by Letters Patent is:

1. A pedestal seat apparatus comprising:
a.) an inner member, said inner member having a tubular configuration;
b.) an outer member, said outer member having a tubular configuration and being sized and shaped to telescopically receive said inner member;
c.) a shock-absorbing means, said shock-absorbing means having a first end and a second end, said first end of said shock-absorbing means being connected to said inner member, said second end of said shock-absorbing means being connected to said outer member;
d.) a bearing means, said bearing means being positioned between said inner member and said outer member, said bearing means being configured from a deformable substrate.

2. The pedestal seat apparatus of claim 1 further comprising a first restraining means, said first restraining means securing said shock-absorbing means to said inner member.

3. The pedestal seat apparatus of claim 2 further comprising a second restraining means, said second restraining means securing said shock-absorbing means to said outer member.

4. The pedestal seat apparatus of claim 1 wherein said inner member has an outer surface and an inner surface, said outer surface of said inner member having a series of lans and grooves.

5. The pedestal seat apparatus of claim 4 wherein said outer member has an outer surface and an inner surface, said inner surface of said outer member having a series of lans and grooves.

6. The pedestal seat apparatus of claim 5 wherein said bearing means has a series of inwardly extending projections and a series of outwardly extending projections, said inwardly extending projections of said bearing element being configured to be complementary to said lans and grooves of said inner member, said outwardly extending projections of said bearing element being configured to be complementary to said lans and grooves of said outer member.
